(19) United States
(12) Patent Application Publication
(10) Pub. No.: US 2025/0235800 A1
(43) Pub. Date: Jul. 24, 2025

(54) METHOD FOR CONTINUOUS MONITORING OF EXTRACTION PROCESS

(71) Applicant: Schlumberger Technology Corporation, Sugar Land, TX (US)

(72) Inventors: Rod Shampine, Sugar Land, TX (US); Dominic Vincent Perroni, Sugar Land,, TX (US)

(21) Appl. No.: 18/698,466

(22) PCT Filed: Oct. 12, 2022
(86) PCT No.: PCT/US2022/046351

§ 371 Date: Apr. 4, 2024

Related U.S. Application Data
(60) Provisional application No. 63/262,393, filed on Oct. 12, 2021.

(51) Int. Cl. B01D 15/10; B01D 15/20; B01D 15/42; C22B 3/24; C22B 26/12; G01F 1/84; G01N 9/32

(52) U.S. Cl. CPC B01D 15/102; B01D 15/203; B01D 15/424; C22B 3/24; C22B 26/12; G01F 1/84; G01N 9/32

(57) ABSTRACT

Continuous monitoring of density in lithium extraction and recovery using inertial density sensors is described herein. Lithium recovery methods and processes using inertial density sensors are also described herein. A method comprises detecting a first density of an aqueous material using an inertial density sensor; performing an operation on the aqueous material to change a lithium concentration of the aqueous material; after performing the operation, detecting a second density of the aqueous material using an inertial density sensor; comparing the first density with the second density; and determining a change in concentration of lithium in the aqueous material based on the comparison.

### CROSS-REFERENCE TO RELATED APPLICATIONS

This patent application claims benefit of U.S. Provisional Patent Application Ser. No. 63/262,393 filed Oct. 12, 2021, which is entirely incorporated herein by reference.

### FIELD

This patent application describes methods and apparatus for lithium recovery from aqueous sources. Specifically, processes and apparatus for monitoring a lithium recovery process are described.

### BACKGROUND

Lithium is a key element in energy storage. Electrical storage devices, such as batteries, supercapacitors, and other devices commonly use lithium to mediate the storage and release of chemical potential energy as electrical current. As demand for renewable, but non-transportable, energy sources such as solar and wind energy grows, demand for technologies to store energy generated using such sources also grows.

According to the United States Geological Survey, global reserves of lithium total 22 million tons (metric) of lithium content, with Chile, Australia, Argentina, and China accounting for about 85% of global reserves. U.S. Geological Survey, Mineral Commodity Summaries, January 2022. According to S&P Global Market Intelligence, lithium supply is forecast to be 636 KT LCE in 2022, up from 497 KT in 2021. Global consumption was estimated at 64 KT in 2021, putting current lithium supplies in deficit. Global consumption and is expected to reach 2 MTa by 2030 for an average annual growth in demand of approximately 13.5%. Supply is currently forecast to run behind demand, and lithium prices currently outstrip even the most optimistic forecasts. While lithium prices are quite volatile as the global market develops, lithium prices are expected to remain high through 2030. The incentive for more lithium production could not be clearer.

Manufacturers are exploring direct extraction methods of recovering lithium from aqueous lithium sources. Such extraction methods typically involve contacting an aqueous lithium source with a lithium-selective medium that withdraws lithium ions from the aqueous lithium source into the medium. The lithium-loaded medium is then contacted with a material that removes the lithium ions from the medium. The medium can be liquid or solid, and the material that removes the lithium ions is typically an aqueous medium that can be pure water or water with acid, base, salt, or combination thereof. Lithium removed from the medium can then be processed into any convenient form, such as lithium carbonate or lithium hydroxide for battery applications.

Direct extraction processes generally rely on monitoring the extraction process to determine when the withdrawal medium is loaded or unloaded to an extent that processing can switch from loading to unloading, or vice versa. The process is also monitored to assess performance of the withdrawal medium so that reduction in performance can be remediated. Currently, continuous methods of monitoring extraction processes, and performance of withdrawal media, do not reliably report lithium content. Lithium content is conventionally monitored using manual analyses that are time consuming and subject to variable error. Continuous monitoring methods that can reliably report lithium content are needed for monitoring of lithium recovery processes.

### SUMMARY

Embodiments described herein provide a method, comprising detecting a first density of an aqueous material using an inertial density sensor; performing an operation on the aqueous material to change a lithium concentration of the aqueous material; after performing the operation, detecting a second density of the aqueous material using an inertial density sensor; comparing the first density with the second density; and determining a change in concentration of lithium in the aqueous material based on the comparison.

Other embodiments described herein provide a method of extracting lithium from a lithium source, the method comprising obtaining an aqueous lithium-bearing material from a lithium source; contacting the aqueous lithium-bearing material with a lithium-selective medium to withdraw lithium ions from the aqueous lithium-bearing material to the lithium-selective medium and form a lithium-depleted aqueous material; determining a first density of the aqueous lithium-bearing material using an inertial density sensor; determining a second density of the lithium-depleted aqueous material using an inertial density sensor; comparing the first density with the second density; discontinuing contacting the aqueous lithium-bearing material with the lithium-selective medium based on the comparison; and after discontinuing contacting the aqueous lithium-bearing material with the lithium-selective medium, contacting an eluent with the lithium-selective medium to remove lithium from the lithium-selective medium and form a lithium extract.

Other embodiments described herein provide a method, comprising extracting lithium from an aqueous lithium-bearing material in an extraction stage to form a lithium extract; transforming the lithium extract into a lithium product in a processing stage; and using an inertial density sensor to control operation of the extraction stage, the processing stage, or both.

Other embodiments described herein provide a method of extracting lithium, comprising providing an aqueous material containing lithium to a direct lithium extraction unit; extracting lithium from the aqueous material containing lithium using a lithium-selective medium to yield a lithium extract and a lithium-depleted material; determining a first density of the aqueous material containing lithium using an inertial density sensor; determining a second density of the lithium-depleted material using an inertial density sensor; comparing the first density with the second density; and operating the direct lithium extraction unit based on the comparison.

Other embodiments described herein provide a method of extracting lithium, comprising contacting an aqueous material containing lithium with a lithium-selective medium in a direct lithium extraction unit to withdraw lithium ions from the aqueous material containing lithium into the lithium-selective medium, to load the lithium-selective medium with lithium ions, and to form a lithium-depleted material; contacting an eluent with the loaded lithium-selective medium to remove lithium ions from the lithium-selective medium and form a lithium extract; determining a first density of the eluent using an inertial density sensor; determining a second density of the lithium extract using an inertial density sensor; comparing the first density with the second density; and operating the direct lithium extraction unit based on the comparison.

### BRIEF DESCRIPTION OF THE DRAWINGS

FIG. 1 is a flow diagram summarizing a method of obtaining a substantially continuous reading of a difference in lithium concentration between two aqueous materials according to one embodiment.

FIG. 2 is a flow diagram summarizing a method of determining lithium content of an aqueous stream where content of lithium and other species change with time according to another embodiment.

FIG. 3 is a flow diagram summarizing a method of recovering lithium from an aqueous source according to another embodiment.

FIG. 4 is a process flow diagram of a lithium recovery process that uses inertial density sensors to provide substantially continuous lithium concentration readings, according to one embodiment.

FIG. 5 is a flow diagram summarizing a method of extracting lithium from an aqueous lithium containing material, according to one embodiment.

### DETAILED DESCRIPTION

It has been discovered that inertial density sensors, such as Coriolis meters, can be used to monitor lithium content of aqueous streams with high accuracy and precision. Sensors that reliably report concentration of non-lithium species can be used to supplement measurements by inertial density sensors to improve accuracy of lithium concentration reporting by such devices.

An inertial density sensor generally works by disposing a material in a container and applying an oscillating force to the container. The container adopts a natural frequency, in response to the oscillating force, that depends on the total mass of the container and the material within the container. If the weight and volume of the container are known, density of the material within the container can be ascertained from the natural frequency.

In many cases, the fluid is provided to a curved fluid pathway, which is oscillated at a known frequency while the fluid occupies the curved fluid pathway. If temperature of the fluid is known, density of the fluid can be determined to high accuracy and precision by measuring changes in the natural oscillation frequency of the curved fluid pathway. Additionally, mass flow through the curved fluid pathway can be determined to high accuracy by flowing the fluid through the curved fluid pathway while the pathway oscillates, and measuring distortion of the curved fluid pathway as the fluid flows. Typically, the curved fluid pathway is designed to lie within a plane to simplify the geometry of the system, and the oscillation is in a direction perpendicular to the plane to enhance accuracy and precision, but any configuration can be used and calibrated to give a measure that can be related to density. More recently, straight-tube versions have been devised and today many variations exist. Mass flow is strongly related to the change in shape of the fluid pathway, and mass of fluid contained within the fluid pathway is strongly related to the natural oscillation frequency of the system. Coriolis mass flow meters and other inertial density sensors are commercially available. Typically, such devices have temperature and density measurement built-in to simplify generating a measurement output.

Density of an aqueous medium varies with ion content, so lithium content can be ascertained in some cases from measurement of the density of the fluid. Contribution of other species to density changes can be compensated by separately measuring content of those species and calibrating for coincident changes in concentration of the other species. For example, the following solutions of lithium chloride in water have the indicated densities at 21° C.:

| Total Dissolved Solids (TDS, ppm) | Density (g/mL) |
|---|---|
| 110,000 | 1.0864 |
| 100,000 | 1.075 |
| 10,000 | 1.0006 |
| 100 | 0.998 |

A properly configured and calibrated inertial density sensor can detect these density differences.

To measure lithium content using such a device, known solutions of lithium can be prepared and provided to the device at different temperatures to obtain density measurements. The readings of temperature and density can be related to the known concentrations of lithium to yield a calibration relation. The calibration relation can be a linear equation based on regression, or other statistical treatment, or the calibration relation can be a table, like the table above, in which density and concentration can be interpolated. Flow rate can also be measured using such an inertial density sensor by flowing the known solutions of lithium through the device and detecting distortion of the fluid pathway to determine mass flow rate.

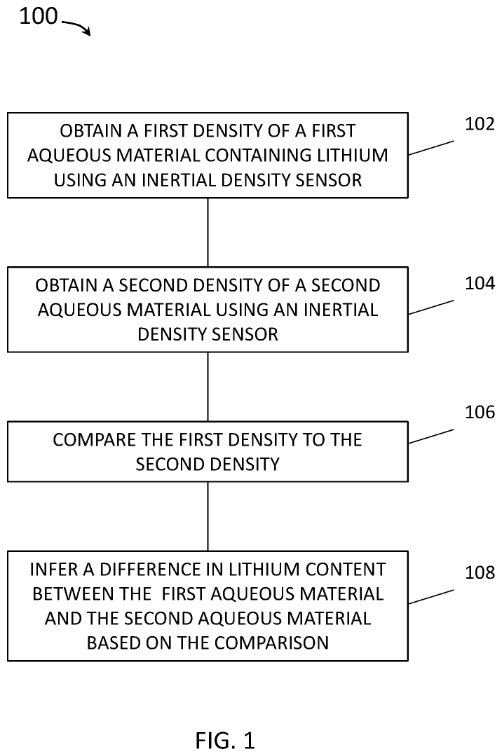

A density difference between two aqueous materials can be used to infer a difference in lithium content. FIG. 1 is a flow diagram summarizing a method 100 according to one embodiment. The method 100 can be used to obtain a difference in lithium concentration between two aqueous materials. At 102, a first density of a first aqueous material containing lithium is obtained using an inertial density sensor. As noted above, the inertial density sensor can be any type, but Coriolis flow meters are common and can be used for these methods.

At 104, a second density of a second aqueous material is obtained using an inertial density sensor. The same inertial density sensor can be used, or a different inertial density sensor can be used. Where the same inertial density sensor is used to obtain the first density and the second density, appropriate flushing capability is provided to avoid cross-contamination between samples of the two aqueous materials. Where two different sensors are used, the two sensors can provide substantially continuous density readings of the two aqueous materials.

At 106, the first density and the second density are compared to ascertain a difference between the densities or a difference in one or more parameters that depend on the densities. The difference in densities can be used to monitor processing of the aqueous materials or to relate the compositions of the materials.

At 108, the comparison is used to infer a difference in lithium content between the first aqueous material and the second aqueous material. The method 100 can be useful where a process removes lithium from the first aqueous material to yield the second aqueous material. The comparison can provide a substantially continuous reading of the lithium removal.

Lithium concentration can be inferred from density, and change in lithium concentration can be inferred from change in density. If concentration of other species in the first and second aqueous materials that affect density thereof are known, and temperature is known, calibration can be used to infer lithium concentration of the first aqueous material from the first density, and of the second aqueous material from the second density. The two concentrations can be compared to understand the change in lithium concentration between the two materials. Known lithium solutions, with and without other species that affect density, can be analyzed using the inertial density sensor or sensors to give calibration curves for inferring lithium concentration from density readings. Additionally or alternately, independent non-inertial sensors can be used to detect content of non-lithium species that affect the density of the aqueous materials. Such non-inertial sensors may be conductivity sensors, pH sensors, spectrum sensors (e.g. IR or UV transmission spectrum analyzers), electrochemical sensors, optical (e.g. colorimetric) sensors, or a combination thereof.

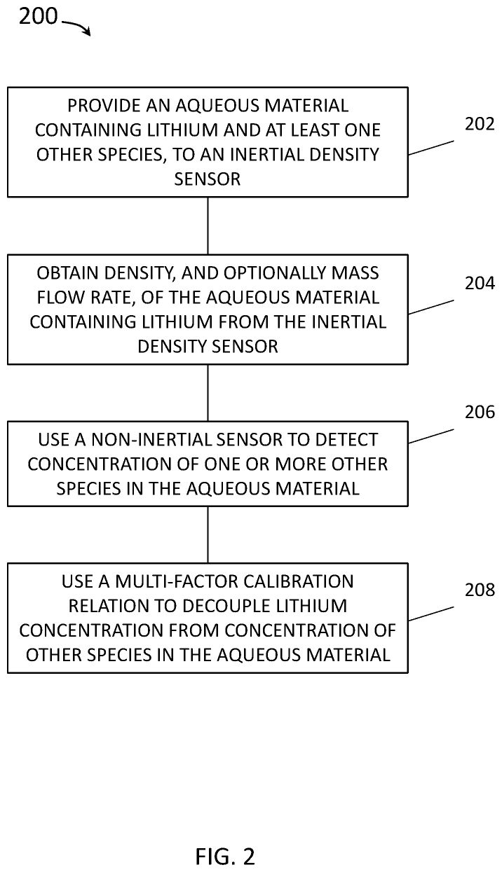

FIG. 2 is a flow diagram summarizing a method 200 according to another embodiment. The method 200 can be used to determine lithium content of an aqueous stream where content of lithium and other species change with time. At 202, aqueous material containing lithium, and optionally other species, is provided to an inertial density sensor. As before, any type of inertial density sensor, such as a Coriolis device can be used. At 204, density and optionally mass flow of the aqueous material are obtained from the inertial density sensor.

At 206, an independent, non-inertial sensor, for example any of the non-inertial sensors described above, is used to detect concentration of one or more other species in the aqueous material. Where changes in one non-lithium species predominate, or where content of all non-lithium species tend to vary together, or where only one non-lithium species is present, one non-inertial sensor can be used to detect concentration of non-lithium species. Where changes in more than one non-lithium species need to be independently decoupled, more than one non-inertial sensor may be used besides the inertial density sensor. Independent non-inertial sensors that can be used include conductivity sensors, pH sensors, spectrum sensors (e.g. IR or UV transmission spectrum analyzers), electrochemical sensors, optical (e.g. colorimetric) sensors, or a combination thereof. Use of multiple, closely calibrated, and independent sensors, and averaging results can improve accuracy and reduce error. Results from multiple independent sensors detecting the same parameter can allow discovery of error conditions with a sensor so that sensor can be remediated.

At 208, a multi-factor calibration relation is used to decouple lithium concentration from concentration of other species. Density readings from the inertial density sensor are calibrated to multiple concentrations of lithium and non-lithium species, at different temperatures, to build the multi-factor calibration relation. When the multi-factor calibration relation is reduced to an equation relating density with lithium concentration and concentration of other species, concentration of non-lithium species detected by a non-inertial sensor can be substituted into the equation, and lithium concentration can be calculated from density readings of the inertial density sensor.

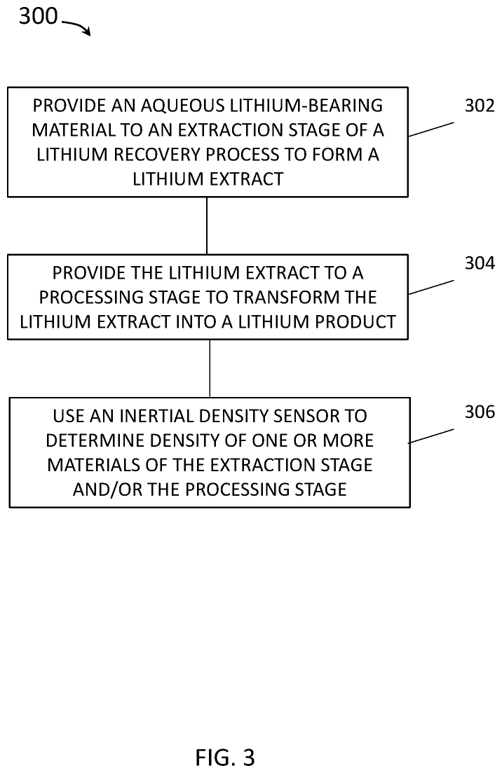

Inertial density sensors can be used in lithium recovery operations. FIG. 3 is a flow diagram summarizing a method 300 according to another embodiment. The method 300 is a method of recovering lithium from an aqueous source.

At 302, an aqueous lithium-bearing material is provided to an extraction stage for recovery of lithium from the aqueous lithium-bearing material. The aqueous lithium-bearing material is obtained from a lithium source, which can be a surface source, such as a salar lake or a generated source (i.e. from washing lithium containing solid materials); a subterranean source, such as water produced from mines and wells; an industrial source, such as an aqueous lithium containing byproduct stream, an ocean source, or any other aqueous lithium source. The lithium source may be a solid or liquid material. For example, the aqueous lithium-bearing material may be obtained directly from a salar lake, or may be obtained by water washing of a lithium-bearing solid material.

The extraction stage uses any suitable method of extracting lithium from the aqueous lithium source to form an aqueous lithium extract. The extraction stage can use any form of direct lithium extraction, in which an aqueous lithium-bearing material is contacted with a lithium-selective medium to withdraw lithium ions from the aqueous lithium-bearing material into the lithium-selective medium, which may be a liquid or a solid. The extraction stage may include Counter-Current Adsorption Desorption (CCAD) processing. Solid lithium selective media, such as a resin treated, coated, or impregnated with materials such as aluminum hydroxide, manganese oxide, or titanium oxide can be used. Phosphorus-based liquid lithium-selective media, such as the LiSX™ solvent extraction medium available from Tenova SpA of Castellanza, Italy, or the CYANEX® 936P extractant available from Solvay S.A. of Brussels, Belgium, can also be used. Other effective liquid extractants have also been reported, such as 3-benzoyl-1,1,1-trifluoroacetone dissolved in 1-ethyl-3-methylimidazolium bis(trifluoromethylsulfonyl)imide.

When the lithium-selective medium is loaded with lithium, an eluent is used to remove the lithium from the lithium-selective medium to form a lithium extract. Concentration of lithium in the lithium extract can be varied and controlled by adjusting a flow rate of the eluent used to remove lithium from the lithium-selective medium. The flow rate can be adjusted to achieve a target lithium concentration in the lithium extract. In the liquid medium context, mixing of any convenient sort can be applied during loading and unloading of the lithium-selective medium.

At 304, the lithium extract is provided to a processing stage to transform the lithium extract into a lithium product. The lithium product can be a lithium concentrate, for example a concentrated lithium chloride solution or slurry or a lithium carbonate solution or slurry, for further processing and/or purification, or the lithium product may be a battery raw material such as a lithium hydroxide solution, slurry, or solid. The processing stage can use one or more of a concentration process, a separation process, or a conversion process to make the lithium product. A concentration process can involve evaporation, for example flashing or other vaporization processes, to remove water from the lithium extract to form a lithium concentrate. A separation process can use a barrier to separate one or more species of the lithium extract. The barrier can be lithium selective. For example, the barrier can selectively block or permit lithium. The barrier can be a membrane, cake, or other barrier, which can be, or contain, a lithium selective material. The conversion process uses a reagent to react with the lithium extract, or another lithium stream such as a lithium concentrate stream, to form the lithium product.

The separation process can use applied energy to enhance the separation. An electrolytic chemical reaction can be used to encourage transport of lithium through a barrier, which may be lithium-selective. Temperature and pressure can also be adjusted to optimize a separation process using a barrier.

In one embodiment, the lithium extract is provided to a concentrator that removes water from the lithium extract by vaporization or filtration to form a lithium concentrate. The lithium concentrate is provided to a conversion process that converts the lithium in the lithium concentrate to lithium hydroxide, either via a lithium carbonate intermediate, or directly to lithium hydroxide in an electrochemical process.

The processes of the processing stage may form solids. For example, concentration may result in lithium salts precipitating if the solubility limit of the lithium salts are reached. In another example, a conversion may add ions that preferentially precipitate one or more lithium salts having lower solubility, forming solids. In any solids-forming process, the processing stage can include solids handling and removal processes, such as filtration or cyclonic processes, to capture and control solids that may be formed in the processing stage. Other processing stages that can be used, instead of or in addition to, the examples described above include ion exchange units, adsorption/desorption units, filtration units, membrane separation units, and moving bed or simulated moving bed units.

At 306, an inertial density sensor is used to determine density of one or more materials of the extraction stage and/or the processing stage. The inertial density sensor can be any of the types of inertial density sensors described herein, and the material may be any or all of the aqueous lithium source, the lithium extract, or any other stream of any embodiment of the process, such as the eluent, the lithium depleted stream, the lithium concentrate stream, the lithium product stream, and any byproduct streams. In one example, a water stream is obtained from the processing stage and routed to the extraction stage for use as an eluent or a diluent. An inertial density sensor can be used to determine density of the water stream and one or more parameters of the processing stage can be adjusted based on the density of the water stream. An inertial density sensor can also be used to determine density of other streams of the extraction and processing stages to compare the readings and infer changes in lithium concentration at different locations. The extraction stage and/or the processing stage can be operated based on the readings from the inertial density sensors.

In the method 300, where concentrations of non-lithium species can change enough to affect the density, a non-inertial sensor can be used, as described above to sense concentration of one or more non-lithium species to provide, or improve, lithium concentration detection. An inertial density sensor can be co-located with a non-inertial sensor, and signals from both sensors routed to a controller to decouple the concentrations of lithium and non-lithium species, which can both be reported and separately controlled.

The methods 100 and 200 can be used with the method 300 to operate the lithium recovery process. In one case, an inertial density sensor is used to determine density, or lithium concentration, of a lithium-depleted stream of a direct lithium extraction process resulting from withdrawal of lithium ions from an aqueous lithium source into a solid lithium-selective medium. Using an inertial density sensor allows substantially continuous measurement of density, or lithium concentration, in the lithium-depleted stream, which can, in turn, enable substantially continuous monitoring of the lithium loading in the ion withdrawal medium. Lithium concentration in the lithium-depleted medium can be monitored, and rise in lithium concentration that cannot be attributed to a change in flow rate or to lithium concentration of the aqueous lithium-bearing material, can be understood as increasing lithium loading of the ion withdrawal medium resulting in incipient breakthrough of lithium to the lithium-depleted stream. Depending on the lithium concentration in the lithium-depleted material, contacting the aqueous lithium-bearing material with the lithium-selective medium can be discontinued if the lithium concentration indicates an endpoint has been reached. Alternately, or additionally, an inertial density sensor can be used to monitor density, or lithium concentration, of the aqueous lithium source, or a material obtained from the aqueous lithium source and provided to the direct lithium extraction process. The density readings of the aqueous lithium source and the lithium-depleted material can be used to infer a change in lithium concentration due to withdrawal of lithium ions in to the lithium-selective medium. The direct lithium extraction process can be monitored and operated based on the substantially continuous readings of density and/or lithium concentration, and differences in the readings.

When the lithium-selective medium is loaded with lithium, as indicated by lithium beginning to break through the lithium-selective medium to the lithium-depleted stream, flow of the aqueous lithium-bearing material to the lithium-selective medium can be discontinued, and an eluent can be contacted with the lithium-selective medium to remove lithium from the lithium-selective medium, thus forming the lithium extract.

A similar process of determining lithium concentration of the lithium extract can be used to determine when the lithium-selective medium has been unloaded to the extent that removal of lithium from the medium is slowing. Lithium concentration of the lithium extract and the eluent can be determined as described herein, using an inertial density sensor, and optionally a non-inertial sensor for non-lithium species. When lithium concentration in the eluent compared with lithium concentration in the lithium extract indicates lithium removal from the lithium-selective medium is slowing, flow of the eluent to the lithium-selective medium can be discontinued, and flow of the aqueous lithium-bearing material restarted for a new cycle. The inertial density sensors can be repeatedly used in this way to detect loading and unloading endpoints.

The various endpoints described above can be defined by comparison to standards. For example, lithium concentration in the lithium-depleted stream can be compared to a standard to determine whether an endpoint has been reached. Alternately, or additionally, difference in density can be compared to a standard to identify the endpoint. In one method, when lithium concentration in the lithium-depleted stream rises to or above a standard lithium concentration value, or approaches the standard, flow of the aqueous lithium-bearing material to the lithium-selective medium can be discontinued and flow of the eluent started. Likewise, when lithium concentration in the lithium extract falls to or below a standard lithium concentration value, or approaches the standard, where the standard for the lithium-depleted stream is a first standard and the standard for the lithium extract is a second standard, flow of the eluent to the lithium-selective medium can be discontinued and flow of the aqueous lithium-bearing material can be restarted. In another method, when absolute value of a difference in density between the aqueous lithium-bearing material and the lithium-depleted material falls to or below a density difference standard, or approaches the density difference standard, flow of the aqueous lithium-bearing material to the lithium-selective medium can be discontinued and flow of the eluent started. Likewise, when absolute value of a density difference between the eluent and the lithium extract falls to or below a density difference standard, or approaches the density difference standard, flow of the eluent can be discontinued and flow of the aqueous lithium-bearing material restarted. In this case, the same density difference standard can be used during the loading and unloading phases, or different density difference standards can be used for the two phases.

The substantially continuous monitoring of density described herein by using inertial density sensors provides the ability to monitor loading capacity of the lithium-selective medium. If an inertial density sensor is used to monitor density of the aqueous lithium-bearing material and the lithium-depleted aqueous material, the difference in density between the materials can indicate that loading capacity of the lithium-selective medium is falling as the medium collects lithium ions. If lithium concentration is determined, for example using non-inertial sensors to report concentration of non-lithium species, and if flow rate of one or both streams is known, then an actual mass-loading of lithium within the lithium-selective medium can be calculated. The density evolution and/or mass-loading of each cycle can be archived for analysis, and a decline in mass-loading per cycle, or mass-loading per cycle reaching or approaching a minimum standard, can indicate that regeneration of the lithium-selective medium is needed. Same approach may be applied to mass-unloading by monitoring density of the lithium extract and the eluent. Regeneration of some lithium-selective media can be performed by exposure to hot water and/or hot gas, which can be done by flowing through the lithium-selective medium, soaking the lithium-selective medium in quiescent hot water, or both. Other media can be regenerated by exposure to reagents that remove lithium. Alternately, or additionally, loading and unloading cycle time can be monitored for indications that regeneration is needed. Decreasing cycle time, or cycle time reaching or approaching a minimum standard, can indicate that a regeneration cycle should be started.

In some cases, a direct lithium extraction process uses a plurality of extractors, each having a lithium-selective medium for contacting with an aqueous lithium-bearing material. Inertial density sensors can be used to monitor operation of each extractor to determine when each extractor reaches a loading endpoint and an unloading endpoint by substantially continuous reporting of density and/or lithium concentration of the input and output streams of each extractor.

In the case of a liquid lithium-selective medium, the inertial density sensors described herein can be used to detect the loading of lithium in the lithium-selective medium itself, using the methods described herein. The inertial density sensor, loaded with the liquid lithium-selective medium, indicates density of the medium, which can be related to lithium loading in a manner substantially similar to methods described above for monitoring loading of a solid lithium-selective medium. Change in density of the liquid lithium-selective medium over time indicates change in composition, and a falling rate of change in density can indicate an endpoint, either of loading or unloading, is approaching.

Substantially continuous monitoring of density and/or lithium concentration in streams of the extraction stage can also be used to optimize extraction performance. Any or all of temperature, pressure, flow rate, pH, cycle time, residence time, moving speed of the lithium-selective medium in a moving bed or simulated moving bed application, or other parameters may be adjusted depending on density, change in density over time, difference in density between two or more materials, lithium concentration, change in lithium concentration, rate of change of lithium concentration, distance from an endpoint, cycle time, mass-loading of the lithium-selective medium, or trend thereof.

As noted above, inertial density sensors can be used for substantially continuous monitoring of density and/or lithium concentration in any stream of a lithium recovery process. For example, in a concentration process where lithium concentration is increased in an aqueous material to yield a lithium concentrate, density and/or lithium concentration in a lithium concentrate stream can be monitored and operation of the concentration process adjusted to optimize or improve performance of the concentration process. Thus, temperature, pressure, flow rate, residence time, or other parameters can be adjusted to achieve a target composition of the lithium concentrate. Likewise, inertial density sensors can be used to monitor performance of a lithium conversion process. Because the lithium conversion process involves changing compositions of many species, non-inertial sensors can be used to monitor multiple non-lithium species, while inertial density sensors are used to monitor density and/or lithium concentration. Using such sensors, conversion of lithium in a feed to the conversion process can be monitored substantially continuously and operation of the conversion process can be adjusted to optimize or improve results.

Where lithium is the primary species in an aqueous material and concentration of other species is much lower than concentration of lithium, density changes in the aqueous material can be primarily attributed to changes in lithium concentration to at least a first approximation. In such cases, a calibration relation or a model can be used to calculate lithium concentration from density readings. Where non-lithium species are removed from an aqueous stream as part of a lithium recovery process, for example using chemical reagents to remove impurities such as sodium, calcium, magnesium, and the like, the resulting stream may have sufficient preponderance of lithium to allow direct determination of lithium concentration from density with fair accuracy. In other cases, as described elsewhere herein, independent non-inertial sensors can be used to directly detect concentration of non-lithium species in the aqueous material to decouple the effects of lithium and other species on density changes.

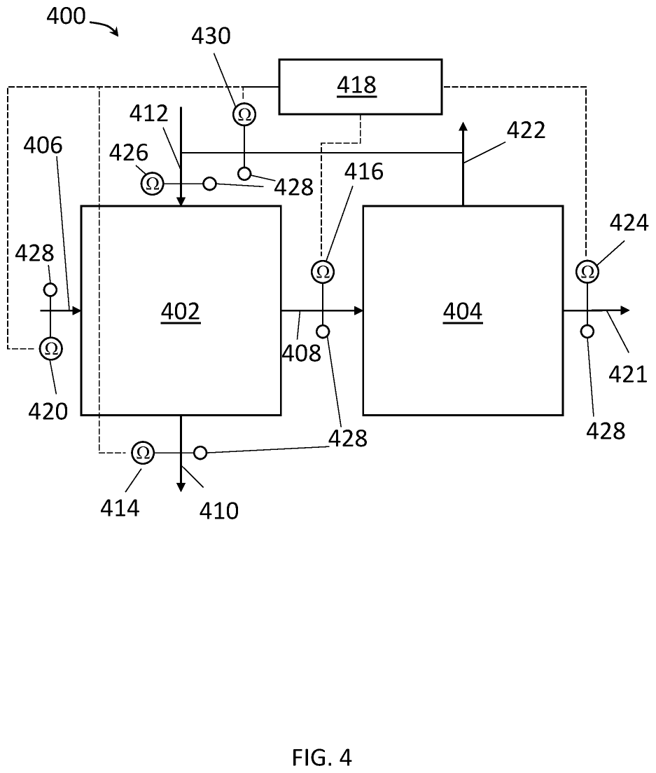

FIG. 4 is a process flow diagram of a lithium recovery process 400, according to one embodiment. The lithium recovery process 400 uses inertial density sensors to provide substantially continuous density and/or lithium concentration readings for multiple lithium-bearing streams, and a controller adjusts the process 400 based on the readings, among other signals.

The lithium recovery process 400 has an extraction stage 402 and a processing stage 404. The extraction stage extracts lithium from an aqueous lithium-bearing material 406 to yield a lithium extract 408 and a lithium-depleted material 410. In this case, the extraction stage uses direct extraction with a solid lithium-selective ion withdrawal medium, so an aqueous eluent 412 is provided to the extraction stage 402 to unload lithium from the medium. The lithium-selective medium withdraws lithium from the aqueous lithium-bearing material to form the lithium-depleted material and the eluent desorbs lithium from the loaded lithium-selective medium in a so as to yield a lithium extract 408.

A first inertial density sensor 414 is coupled to the lithium-depleted material 410, and a second inertial density sensor 416 is coupled to the lithium extract 408, to provide substantially continuous readout of density and/or lithium concentration so that loading and unloading of the lithium-selective medium can be tracked. A controller 418 is operatively coupled to the first and second inertial density sensors 414 and 416 and to the extraction stage 402 to control operation of the extraction stage 402, for example loading and unloading start and stop and operating parameters like temperature, pressure, flow rate, and moving speed in a moving bed or simulated moving bed application, based on signals from the inertial density sensors 414 and 416. The inertial density sensors 414 and 416 may also be mass flow devices. As described above, an inertial density sensor can be configured to deform as material flows through the fluid pathway of the device to provide an accurate measure of the mass flow rate.

The controller 418 can be configured to interpret signals from the inertial density sensors 414 and 416 to resolve density and/or lithium concentration in the lithium-depleted material 410 and the lithium extract 408. Thus, signals from the inertial density sensors 414 and 416 may represent the oscillating frequency of the fluid pathways of the sensors, and the controller 418 can in that case be configured to calculate density from the frequency signals using well-known harmonic physics methods. Alternately or additionally, the inertial density sensors 414 and 416 may be configured with computing capability to calculate density and/or lithium concentration of the lithium-depleted material 410 and the lithium extract 408, using a calibration relation and/or using signals from non-inertial sensors, as described above, so that signals received by the controller 418 from the inertial density sensors 414 and 416 represent density of the respective materials.

An optional third inertial density sensor 420 can be coupled to the aqueous lithium-bearing material 406, and operatively coupled to the controller 418, to provide substantially continuous readout of density and/or lithium concentration in the aqueous lithium-bearing material 406, so that composition in the various streams can be compared and balanced to understand performance of the extraction stage 402. For example, as noted above, the controller 418 can be configured to compute and track parameters such as mass-loading of the lithium-selective medium, loading and unloading cycle time, and comparison to standards.

The processing stage 404 transforms the lithium extract 408 into a lithium product 421 and a byproduct 422. Depending on the operations performed in the processing stage 404, the lithium product 421 may be a lithium chloride product, a lithium carbonate product, a lithium hydroxide product, or a mixture. In one case, the processing stage 404 has a concentrator that removes water from the lithium extract 408 to yield a lithium concentrate and a water stream. The byproduct 422 may be, or may include, the water stream. An optional fourth inertial density sensor 424 is coupled to the lithium product 421, and operatively coupled to the controller 418, to provide substantially continuous readings of density and/or lithium concentration in the lithium product 421. The fourth inertial density sensor 424 is configured and calibrated based on the composition of the lithium product 421, whether a lithium chloride product, a lithium carbonate product, a lithium hydroxide product, or a mixture thereof. The processing stage can also include a conversion unit to convert the lithium in the lithium extract 408, the lithium concentrate produced by the concentrator, or both in any mixture, into the lithium product 421. For example, the conversion unit may use sodium carbonate to convert lithium chloride to lithium carbonate. In such a case, the byproduct 422 will include sodium, and can be characterized as primarily a sodium chloride stream. In another example, lithium carbonate can be converted to lithium hydroxide by reaction with calcium oxide or calcium hydroxide. In such a case, the byproduct 422 will include calcium, which may precipitate as calcium carbonate.

Optionally, a fifth inertial density sensor 426 can be coupled to the eluent 412, and operatively coupled to the controller 418, to determine density and/or lithium concentration of the eluent 412. As described above, density of the eluent can be compared with density of the lithium extract 408 to monitor unloading of lithium ions from the lithium-selective medium of the extraction stage 402 and to determine when the unit can be switched from unloading to loading mode by discontinuing flow of the eluent and restarting flow of the aqueous lithium-bearing material 406. Parameters related to performance of the lithium-selective medium like extent of mass-loading and -unloading can also be determined and tracked to determine when the lithium-selective medium needs to be regenerated, for example when a degree or amount of mass-loading before the lithium-selective medium stops withdrawing lithium ions from the aqueous lithium-bearing material falls to near, at, or below a standard, or when a degree or amount of mass-unloading before the lithium-selective medium stops releasing lithium ions to the eluent falls to near, at, or below a standard.

Where appropriate and useful, some or all of the byproduct 422 can be routed to the extraction stage 402 for use as, or with, the eluent 412. An optional sixth inertial density sensor 430 can be coupled to the recycled portion of the byproduct 422, and operatively coupled to the controller 418, to determine density and/or lithium concentration of the recycled portion of the byproduct 422 to control composition of the eluent 412. In some cases, a small concentration of lithium ions in the eluent 412 can be helpful to performance of the extraction stage 402. The controller 418 can be configured to adjust flow rates of the eluent 412 and the recycled portion of the byproduct 422, based on density and/or lithium concentration determined by the fifth inertial density sensor 426, the sixth inertial density sensor 430, or both, to target a composition of the eluent 412 for best results in the extraction stage 402.

The process 400 uses inertial density sensors to provide substantially continuous readings of density and/or lithium concentration in one or many materials of the process 400. Materials other than the materials indicated in FIG. 4 can be monitored using inertial density sensors. For example, multiple feed streams and eluent streams of the extraction stage 402 can be monitored if the extraction stage contains multiple extraction units. Multiple materials of the processing stage 404, such as lithium concentrate streams, converted lithium streams, and streams separated in the processing stage 404 such as byproduct streams, can also be monitored using inertial density sensors. The controller 418 can be configured and operatively coupled to all the inertial density sensors to control multiple aspects of the operation of the process 400 to achieve desired results in the lithium product 421, or desired operating profiles of the process 400, such as energy efficiency and environmental impact. As an example of the latter, the controller 418 can be configured to adjust flow rate of the lithium-depleted material 410 to the environment or to remediation before being returned to the environment, based on density and/or lithium concentration determined by the first inertial density sensor 414.

Where necessary, a non-inertial sensor 428 can be co-located with, or coupled to the same material as, each inertial density sensor of the process 400, to provide independent detection of other species in each material that may affect changes to the density of the material, so those effects can be decoupled. The controller 418 can be configured to, and operatively coupled with, the non-inertial sensors 428 to receive signals representing species to be detected by each non-inertial sensor 428 and to decouple concentration of such species from lithium concentration using a multi-factor calibration relation, as described above.

It should be noted that, where a single controller is operatively coupled to more than one inertial density sensor, accuracy of comparing readings from the plurality of inertial density sensors can be improved. For example, the same calibrant fluid can be provided to more than one inertial density sensor, operatively coupled to a single controller, at the same time, and the controller can be calibrated to remove any bias between the readings from the inertial density sensors. In this way, accuracy of differential density measurements using inertial density sensors can be improved.

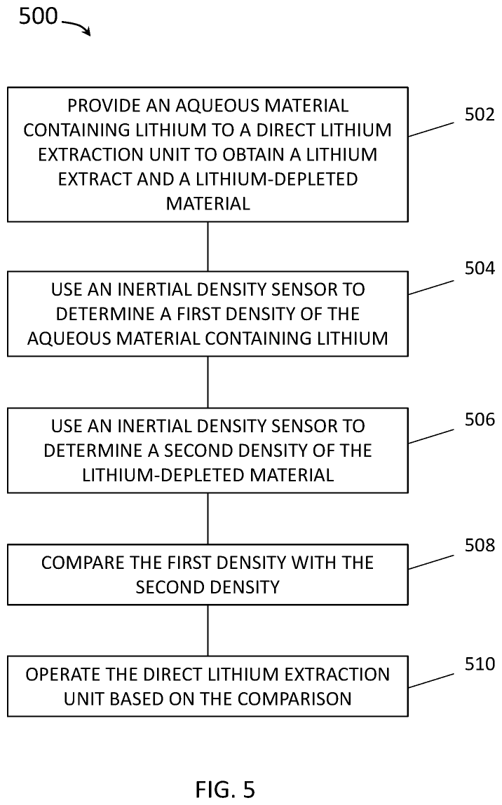

In some cases, operation of a lithium recovery process can be controlled using density determined by an inertial density sensor without resolving lithium concentration from the density. FIG. 5 is a flow diagram summarizing a method 500, according to one embodiment. The method 500 is a method of operating a direct lithium extraction unit. At 502, an aqueous material containing lithium is provided to a direct lithium extraction unit to obtain a lithium extract and a lithium-depleted material. As described above, a direct lithium extraction unit contacts an aqueous material containing lithium with a lithium-selective medium to withdraw lithium ions from the aqueous material containing lithium into or onto the lithium-selective medium, resulting in a lithium-depleted aqueous material effluent from the direct lithium extraction unit. Lithium ions collect in the lithium-selective medium until an endpoint is reached, for example when the medium has no remaining capacity to withdraw lithium ions. At that point, flow of the aqueous material containing lithium can be stopped, and an eluent can be contacted with the loaded lithium-selective medium to remove lithium from the lithium-selective medium and form a lithium extract. The direct lithium extraction unit thus yields a lithium extract and a lithium-depleted stream using the aqueous material containing lithium and the eluent as inputs.

The method 500 uses density change between inputs and outputs of the direct lithium extraction unit to control operation of the unit. At 504, a first density of the aqueous material containing lithium is determined using an inertial density sensor as described above. At 506, a second density of the lithium-depleted material is determine using an inertial density sensor. It should be noted that one inertial density sensor can be used to determine the first and second densities, or two different inertial density sensors can be used. Where one inertial density sensor is used, appropriate flushing capability is provided to ensure no cross-contamination occurs when sampling the two materials. At 508, the first and second densities are compared, typically using a digital controller operatively coupled to the inertial density sensor or sensors. The comparison can be a simple difference, a ratio, or a parameter output by a physical model of the direct lithium extraction unit that represents physical properties of the lithium-selective medium.

At 510, the direct lithium extraction unit is operated based on the comparison of 508. Temperature and pressure of the unit and/or the aqueous feed to the unit can be adjusted. Flow rate and composition of the aqueous feed to the unit can also be adjusted. For example, composition of ionic species within the aqueous material containing lithium can be adjusted based on the comparison, for example if a physical model of the lithium-selective medium indicates operation can be improved by such adjustment. In another example, pH of the aqueous material containing lithium can be adjusted, and can also be separately monitored using a pH probe. Moving speed of the lithium-selective medium during the ion withdrawal process, where a moving bed or simulated moving bed configuration of the lithium-selective medium is used, can also be adjusted. A digital controller is typically used, as in FIG. 4, to adjust operation of the direct lithium extraction unit based on the comparison. The controller receives signals from the inertial density sensor or sensors, along with any other sensors such as temperature, pressure, or composition sensors (i.e. pH sensors, temperature sensors, pressure sensors, conductivity sensors, electrochemical sensors, optical sensors, and the like), and is configured to perform the comparison of the first and second densities according to any convenient process and to apply the result to adjust operation of the direct lithium extraction unit.

In another embodiment, operating the direct lithium extraction unit based on the comparison may include determining an endpoint and changing operating mode of the direct lithium extraction unit. As the lithium-selective medium is loaded with lithium ions, the incremental amount of lithium removed from the aqueous material containing lithium declines, and the composition, and therefore the density, of the lithium-depleted material approaches that of the aqueous material containing lithium. Thus, the comparison of the first and second densities can be used to determine when the lithium-selective medium has become sufficiently loaded with lithium ions to discontinue flow of the aqueous material containing lithium to the direct lithium extraction unit. After flow of the aqueous material containing lithium is discontinued, an eluent can be provided to the direct lithium extraction unit, and contacted with the loaded lithium-selective medium, to remove lithium ions from the lithium-selective medium and to yield the lithium extract. Likewise, density difference between the eluent and the lithium extract can be used to determine when removal of lithium ions from the lithium-selective medium indicates the lithium-selective medium has been sufficiently unloaded of lithium ions to discontinue contacting the lithium-selective medium with the eluent and restart flow of the aqueous material containing lithium.

A third density of an intermediate aqueous material of the direct lithium extraction unit can also be determined using an inertial density sensor to monitor performance of the direct lithium extraction unit. In some cases, a plurality of density readings can be taken at different locations of the direct lithium extraction unit to monitor change in the rate of lithium loading or unloading at different locations in the lithium-selective medium. For example, where flow of aqueous material containing lithium or eluent is linear through the direct lithium extraction unit, a plurality of density readings can be used to monitor rise of fall of lithium loading throughout the bed of the lithium-selective medium. In such configurations, rise in lithium loading can be expected to be fastest near a feed location of the unit where aqueous material containing lithium first contacts the lithium-selective medium, and slowest near where lithium-depleted material exits the unit. Likewise, fall in lithium loading can be expected to be fastest near where eluent is provided to the unit and slowest near where lithium extract is withdrawn from the unit. Change in the loading profile of the lithium-selective medium can be ascertained, substantially continuously, by monitoring density of the aqueous material present at a plurality of locations in the direct lithium extraction unit. Thus, density of an intermediate aqueous material of the direct lithium extraction unit can be determined using an inertial density sensor.

In an example embodiment, a density of the aqueous lithium-bearing material, at 35° C., can be 1074.680 kg/m³, and density of the lithium-depleted material, at a temperature between ambient temperature and 35° C., can be 1075.000 kg/m³, for a density difference of 0.320 kg/m³. Density of the eluent, at 80° C., can be 997.443 kg/m³, and density of the lithium extract, at a temperature between ambient temperature and 80° C., can be 1004.270 kg/m³. As described above, these density differences will change with operation of the extraction unit, and substantially continuous monitoring of the density of the streams using inertial density sensors of sufficient accuracy to allow comparison of the results, can provide good control of a lithium extraction unit.

Thus, a change in lithium concentration in an aqueous medium due to an operation can be detected by detecting a first density of the aqueous material using an inertial density sensor; performing an operation on the aqueous material to change a lithium concentration of the aqueous material; after performing the operation, detecting a second density of the aqueous material using an inertial density sensor; comparing the first density with the second density; and determining a change in concentration of lithium in the aqueous material based on the comparison. Mass flow rate of the aqueous material can also be detected using any of the inertial density sensors, any of which can be a Coriolis device, as described above. Density readings can be of the inertial density sensors can be used with a calibration relation to determine lithium concentration of the aqueous material. As also described above, with respect to any embodiment described herein, a non-inertial sensor can also be used to detect concentration of a non-lithium species in the aqueous material. Doing so can improve accuracy of the detected lithium concentration. The non-inertial sensor can be a pH sensor, a conductivity sensor, an electrochemical sensor, an optical sensor, a spectrum sensor, or another suitable sensor.

The methods and apparatus described herein can be used in a lithium extraction operation by obtaining an aqueous lithium-bearing material from a lithium source; contacting the aqueous lithium-bearing material with a lithium-selective medium in a direct extraction unit to withdraw lithium ions from the aqueous lithium-bearing material to the lithium-selective medium and form a lithium-depleted aqueous material; determining a first density of the aqueous lithium-bearing material using an inertial density sensor; determining a second density of the lithium-depleted aqueous material using an inertial density sensor; comparing the first density with the second density; discontinuing contacting the aqueous lithium-bearing material with the lithium-selective medium based on the comparison; and after discontinuing contacting the aqueous lithium-bearing material with the lithium-selective medium, contacting an eluent with the lithium-selective medium to remove lithium from the lithium-selective medium and form a lithium extract. One or more inertial density sensors can also be used to detect a third density of the lithium extract and a fourth density of the eluent. The third and fourth densities can be compared in a second comparison, and contacting the eluent with the lithium-selective medium can be discontinued based on the second comparison. Lithium concentration of the lithium extract can be determined using the third density and a calibration relation.

A density of an intermediate aqueous material in the direct extraction unit can also be determined using an inertial density sensor. The direct extraction unit usually uses a vessel to bring the aqueous material into contact with the lithium-selective medium. A stream of aqueous material can be obtained using a port provided in the vessel, for example in a side wall of the vessel, and the obtained aqueous material provided to an inertial density sensor to determine the density of the aqueous material withdrawn from the direct extraction unit. In general, one inertial density sensor can be used to determine the various densities (i.e. first, second, third, fourth densities, etc.) mentioned above, or each inertial density sensor can be a different sensor. As described above, where one inertial density sensor is used to determine density of more than one aqueous material, appropriate flushing of the inertial density sensor between readings will reduce cross-contamination of samples.

Lithium concentration of the aqueous lithium-bearing material can be determined using a non-inertial sensor to detect concentration of non-lithium species in the aqueous lithium-bearing material, and based on the detected concentration of non-lithium species and the first density, determining the lithium concentration. Flow rate of the aqueous lithium-bearing material can be varied based on comparison of the first and second densities mentioned above.

Inertial density sensors can be used in a method comprising extracting lithium from an aqueous lithium-bearing material in an extraction stage to form a lithium extract; transforming the lithium extract into a lithium product in a processing stage; and using an inertial density sensor to control operation of the extraction stage, the processing stage, or both. The extraction stage can use a solid lithium-selective medium to withdraw lithium ions from the aqueous lithium-bearing material to form a lithium-depleted material. In this case, the inertial density sensor is a first inertial density sensor coupled to the aqueous lithium-bearing material to determine a first density of the aqueous lithium-bearing material, and a second inertial density sensor is coupled to the lithium-depleted material to determine a second density of the lithium-depleted material. A difference in density between the aqueous lithium-bearing material and the lithium-depleted material can be used to control operation of the extraction stage, the processing stage, or both. In one case, the extraction stage uses an eluent to remove the lithium ions from the lithium-selective medium to form the lithium extract, a third inertial density sensor is used to determine a third density of the eluent, a fourth inertial density sensor is used to determine a fourth density of the lithium extract, and a difference in density between the eluent and the lithium extract is used to control operation of the extraction stage, the processing stage, or both. The processing stage can include a concentrator that removes water from the lithium extract to form a lithium concentrate, and a third inertial density sensor can be coupled to the lithium concentrate to determine density and/or lithium concentration of the lithium concentrate.

Inertial density sensors can be used in a method of extracting lithium, comprising providing an aqueous material containing lithium to a direct lithium extraction unit; extracting lithium from the aqueous material containing lithium using a lithium-selective medium to yield a lithium extract and a lithium-depleted material; determining a first density of the aqueous material containing lithium using an inertial density sensor; determining a second density of the lithium-depleted material using an inertial density sensor; comparing the first density with the second density; and operating the direct lithium extraction unit based on the comparison. In this case, the inertial density sensor used to determine the first density and the inertial density sensor used to determine the second density can be different sensors or the same sensor. Operating the direct lithium extraction unit based on the comparison can include adjusting a temperature, pressure, flow rate, or composition of the aqueous material containing lithium, or moving speed of the lithium-selective medium, based on the comparison. Operating the direct lithium extract unit based on the comparison can include discontinuing flow of the aqueous material containing lithium at a time determined based on the comparison, and after discontinuing flow of the aqueous material, flowing an eluent to the direct lithium extraction unit to yield the lithium extract. Operating the direct lithium extract unit based on the comparison can include regenerating the lithium-selective medium. This method can include determining a third density of an intermediate aqueous material of the direct lithium extraction unit using an inertial density sensor, and can include operating the direct lithium extraction unit based on the third density.

Inertial density sensors can be used in a method of extracting lithium, comprising contacting an aqueous material containing lithium with a lithium-selective medium in a direct lithium extraction unit to withdraw lithium ions from the aqueous material containing lithium into the lithium-selective medium, to load the lithium-selective medium with lithium ions, and to form a lithium-depleted material; contacting an eluent with the loaded lithium-selective medium to remove lithium ions from the lithium-selective medium and form a lithium extract; determining a first density of the eluent using an inertial density sensor; determining a second density of the lithium extract using an inertial density sensor; comparing the first density with the second density; and operating the direct lithium extraction unit based on the comparison.

While the foregoing is directed to embodiments of the present invention, other and further embodiments of the present disclosure may be devised without departing from the basic scope thereof, and the scope thereof is determined by the claims that follow.

1. A method, comprising:
detecting a first density of an aqueous material using an inertial density sensor;
performing an operation on the aqueous material to change a lithium concentration of the aqueous material;
after performing the operation, detecting a second density of the aqueous material using an inertial density sensor;
comparing the first density with the second density; and
determining a change in concentration of lithium in the aqueous material based on the comparison.

2. The method of claim 1, further comprising detecting mass flow rate of the aqueous material using the inertial density sensor.

3. The method of claim 1, wherein the inertial density sensor used to detect the first density is a Coriolis device, the inertial density sensor used to detect the second density is a Coriolis device, or both.

4. The method of claim 1, further comprising determining lithium concentration of the first aqueous material using a calibration relation with the first density, the second density, or both.

5. The method of claim 4, further comprising using a non-inertial sensor to detect concentration of a non-lithium species in the aqueous material.

6-9. (canceled)

10. The method of claim 1, further comprising varying a flow rate of the aqueous lithium-bearing material based on the comparison of the first and second densities.

11. (canceled)

12. The method of claim 5, further comprising determining concentration of lithium in the aqueous lithium-bearing material based on the first density and the concentration of the non-lithium species in the aqueous lithium-bearing material.

13. A method, comprising:
extracting lithium from an aqueous lithium-bearing material in an extraction stage to form a lithium extract;
transforming the lithium extract into a lithium product in a processing stage; and
using an inertial density sensor to control operation of the extraction stage, the processing stage, or both.

14. The method of claim 13, wherein the extraction stage uses a solid lithium-selective medium to withdraw lithium ions from the aqueous lithium-bearing material to form a lithium-depleted material, the inertial density sensor is a first inertial density sensor coupled to the aqueous lithium-bearing material to determine a first density of the aqueous lithium-bearing material, a second inertial density sensor is coupled to the lithium-depleted material to determine a second density of the lithium-depleted material, and a difference in density between the aqueous lithium-bearing material and the lithium-depleted material is used to control operation of the extraction stage, the processing stage, or both.

15. The method of claim 14, wherein the extraction stage uses an eluent to remove the lithium ions from the lithium-selective medium to form the lithium extract, a third inertial density sensor is used to determine a third density of the eluent, a fourth inertial density sensor is used to determine a fourth density of the lithium extract, and a difference in density between the eluent and the lithium extract is used to control operation of the extraction stage, the processing stage, or both.

16. The method of claim 15, wherein the processing stage includes a concentrator that removes water from the lithium extract to form a lithium concentrate, and a third inertial density sensor is coupled to the lithium concentrate to determine lithium concentration of the lithium concentrate.

17. A method of extracting lithium, comprising:
providing an aqueous material containing lithium to a direct lithium extraction unit;
extracting lithium from the aqueous material containing lithium using a lithium-selective medium to yield a lithium extract and a lithium-depleted material;
determining a first density of the aqueous material containing lithium using an inertial density sensor;
determining a second density of the lithium-depleted material using an inertial density sensor;
comparing the first density with the second density; and
operating the direct lithium extraction unit based on the comparison.

18. The method of claim 17, wherein the inertial density sensor used to determine the first density and the inertial density sensor used to determine the second density are different sensors.

19. The method of claim 17, wherein operating the direct lithium extraction unit based on the comparison comprises adjusting a temperature, pressure, flow rate, or composition of the aqueous material containing lithium, or moving speed of the lithium-selective medium, based on the comparison.

20. The method of claim 17, wherein operating the direct lithium extract unit based on the comparison comprises discontinuing flow of the aqueous material containing lithium at a time determined based on the comparison, and after discontinuing flow of the aqueous material, flowing an eluent to the direct lithium extraction unit to yield the lithium extract.

21. The method of claim 17, further comprising determining a third density of an intermediate aqueous material of the direct lithium extraction unit using an inertial density sensor.

22. The method of claim 21, further comprising operating the direct lithium extraction unit based on the third density.

23. The method of claim 21, wherein operating the direct lithium extraction unit based on the comparison comprises regenerating the lithium-selective medium.

24. (canceled)
